(19) United States
(12) Patent Application Publication
(10) Pub. No.: US 2018/0212982 A1
(43) Pub. Date: Jul. 26, 2018

(54) NETWORK SYSTEM, NETWORK CONTROLLER, AND NETWORK CONTROL METHOD

(71) Applicant: ALAXALA Networks Corporation, Kawasaki-shi (JP)

(72) Inventors: Hiroyuki Yoshino, Kawasaki-shi (JP); Masaya ARAI, Kawasaki-shi (JP)

(21) Appl. No.: 15/865,344

(22) Filed: Jan. 9, 2018

(30) Foreign Application Priority Data
Jan. 23, 2017 (JP) 2017-009098
May 25, 2017 (JP) 2017-103184

(51) Int. Cl. H04L 29/06; H04L 12/24; H04L 12/931; H04L 29/12

(52) U.S. Cl. CPC H04L 63/1416; H04L 63/1441; H04L 63/0227; H04L 2012/4629; H04L 49/602; H04L 61/103; H04L 61/6022; H04L 41/0803

(57) ABSTRACT

To identify a network device connected with a terminal by combining not only ARP information and FDB information but also LLDP information. An interruption message is replied to a web access of a user to display the interruption message on a web browser to notify the user of interruption of communication.

### BACKGROUND OF THE INVENTION

### 1. Field of the Invention

The present invention relates to setting of information to a network device, and especially relates to a technology to set information for interrupting an attack detected within a network to a network device.

### 2. Description of the Related Art

In recent years, targeted cyber attacks to cause unauthorized programs to intrude into companies and organizations through the Internet by exploiting someone's feelings and preying on the vulnerability of information systems. The targeted cyber attacks have been highly developed, sophisticated, and diversified year by year. As means to counter the attacks, behavior detection devices that find out an attack from a behavior of an operation of software or communication on the network have been put into practical use. Among the behavior detection devices, a behavior detection device, which finds out an attack from a behavior of communication on the network, monitors traffic mirrored from a network device, and detects intrusion of suspicious data from an external network, connection from an internal network to an unauthorized website in an external network, suspicious communication and files, and abnormality by statistical analysis or the like, thereby to detect an attack that cannot be detected through matching with pattern files in a virus definition document.

Further, with a view to minimize damage by performing prompt initial response if an unauthorized program intrudes into a company or an organization by a targeted cyber attack, a solution has been proposed, which causes a behavior detection device and a software defined networking (SDN) technology to cooperate with each other to automate interruption/separation of a network by an SDN cooperative adapter, using an event detected by the behavior detection device as a trigger.

Non-Patent Literature 1:

http://jpn.nec.com/sdn/pdf/NEC_SDN_cyber_trendmicro.pdf

### SUMMARY OF THE INVENTION

The above-described behavior detection device detects suspicious communication, and outputs details of communication such as a destination internet protocol (IP) address, a transmission source IP address, and a protocol type. In a case of performing interruption/separation of communication in cooperation with the behavior detection device, an IP address is specified and an interruption instruction of communication is output to the network side. There is a technology described in JP-10-56451-A as a method of identifying a terminal from a specified IP address. In identification of a terminal based on an address resolution protocol (ARP) table in JP-10-56451-A, only up to a layer 3 switch can be identified in a case where layer 3 switches are included in the network. In a case where the network is a network having a hierarchical structure further including layer 2 switches, even if a layer 3 switch is identified and a filter for interrupting communication is set to the layer 3 switch, an unauthorized program infects another terminal in layer 2 relay between layer 2 switches, and spreading of the damage cannot be prevented.

In a case of a command and control (C & C) server that causes the interruption target IP address notified from the behavior detection device to output an instruction to the unauthorized program, a filter to interrupt communication may just be set to a point of contact with the C & C server, that is, a port of a network device directly in contact with the Internet. By the setting, even if there is a terminal undetected by the behavior detection device although an unauthorized program is hidden by an attack, communication between the terminal and the C & C server can also be interrupted, and the point of contact is the efficient and optimum communication interruption position with a small application number of filters. The port directly connected with the Internet is known from the network configuration, and the optimum communication interruption position for the C & C server can be determined by an administrator in advance.

Meanwhile, in a case of an IP address of a terminal, the IP address being an interruption target IP address notified from the behavior detection device and infected with the unauthorized program, identification of an optimum communication interruption position is not easy. In this case, setting a filter to a port of a layer 2 switch directly connected with the terminal with a local area network (LAN) cable is the efficient and optimum communication interruption position, where communication to another sub net, and layer 2 relayed-communication in the same network device can be interrupted, and the application number of filters is least. However, only the IP address is notified from the behavior detection device. Therefore, in a conventional terminal identification technology, a media access control (MAC) address of the terminal is obtained from address resolve protocol (ARP) information learned by a layer 3 switch, and a port that has learned the MAC address from the filtering database (FDB) information is employed as an application target candidate of the filter. However, there is a problem that, in a network configuration in which a plurality of layer 2 switches is hierarchized, which layer 2 switch is directly connected with the terminal or is a network device with the least number of hops cannot be identified from only the FDB information.

Further, a user of a terminal of which communication has been interrupted cannot distinguish whether the terminal cannot reach a network due to breakdown of a device, or whether the communication has been interrupted due to infection of an unauthorized program.

Further, in a case where the terminal infected with an unauthorized program is connected with a port of another layer 2 switch or the IP address of the terminal is changed because the terminal is carried out or the like, movement of the port or change of the IP address needs to be detected, and the optimum communication interruption position needs to be re-identified.

The present invention has been made for solving the above-described problems, and an objective is to provide a technology to set a filter for interrupting communication of a terminal infected with an unauthorized program to an appropriate position in a network to realize the interruption of communication with a least number of filters.

Further, an objective of the present invention is to enable a user of a terminal of which communication has been interrupted to distinguish whether the terminal cannot reach a network due to breakdown of the device, or whether the communication has been interrupted due to infection of an unauthorized program.

Further, an objective of the present invention is to re-identify a communication interruption position and interrupt communication in a case where a terminal infected with an unauthorized program is connected to another port or in a case where an IP address of the terminal is changed.

To solve the above-described problems, in the present invention, as an example,
a network system including at least one layer 3 switch and a plurality of layer 2 switches, the network system further including:
a behavior detection unit configured to monitor a behavior of communication of the network system and detect an attack; and
a network management unit configured to receive a detection result output by the behavior detection unit, identify a target switch for which setting for interrupting the attack detected by the behavior detection unit is to be performed, from the layer 3 switch and the layer 2 switches, on the basis of information for associating the detection result and an address allocated to a terminal device accommodated in a switch, learning information of ports of the switches, and adjacency information of the switches, and perform the setting for interrupting the attack to the identified switch.

To be specific, in a case where the detection result output by the behavior detection unit is an IP address of an attacked terminal device, the network management unit identifies a layer 2 switch having a smallest number of hops from the attacked terminal device, on the basis of information for associating the IP address of the attacked terminal device and the address allocated to a terminal device accommodated in a switch, the learning information of ports of the switches, and the adjacency information of the switches, and sets a filter that interrupts communication of the attacked terminal device to the identified layer 2 switch.

Further, in a case where a state of a terminal device of an interruption target of communication has been changed, the identification of the target switch for which setting for interrupting the attack is to be performed and the setting for interrupting the attack are performed again.

Further, an interruption message notification unit that notifies interruption of communication because the attack has been detected, to the terminal device of which the communication has been interrupted.

According to the present invention, a filter for interrupting communication of a terminal infected with an unauthorized program can be set to an appropriate position in a network, and the interruption of communication can be realized with a least number of filters.

Further, the present invention enables a user of a terminal of which communication has been interrupted to distinguish whether the terminal cannot reach a network due to breakdown of a device, or whether the communication has been interrupted due to infection of an unauthorized program.

Further, interruption of communication at an optimum position in a network can be continued in a case where a terminal infected with an unauthorized program is connected to a port of another device, or in a case where an IP address of the terminal infected with an unauthorized program is changed.

### BRIEF DESCRIPTION OF THE DRAWINGS

FIG. 1 is a diagram for describing a network system configuration in an embodiment of the present invention;

FIG. 2 is a diagram for describing a configuration of a network management server in an embodiment of the present invention;

FIG. 3 is a diagram for describing a configuration of a network device in an embodiment of the present invention;

FIG. 4 is a diagram illustrating ARP information collected by a controller;

FIG. 5 is a diagram illustrating FDB information collected by a controller;

FIG. 6 is a diagram illustrating LLDP information collected by a controller;

FIG. 7 is a sequence diagram illustrating a communication interruption operation of a network management server in an embodiment of the present invention;

FIG. 8 is a flowchart illustrating a setting operation of a network management server in an embodiment of the present invention;

FIG. 9 is a diagram illustrating filter setting target device narrowing information created by a controller by a combination of ARP information and FDB information;

FIG. 10 is a diagram illustrating filter setting target device identifying information created by a controller by a combination of ARP information, FDB information, and LLDP information;

FIG. 11 is a diagram for describing a configuration of a network management server in an embodiment of the present invention;

FIG. 12 is a diagram for describing port movement monitoring information in an embodiment of the present invention;

FIG. 13 is a diagram illustrating FDB information in an embodiment of the present invention;

FIG. 14 is a flowchart for describing processing of setting port movement monitoring information in an embodiment of the present invention;

FIG. 15 is a flowchart for describing processing of a port movement monitoring unit in an embodiment of the present invention;

FIG. 16 is a diagram for describing a configuration of a network management server in an embodiment of the present invention;

FIG. 17 is a diagram for describing IP change monitoring information in an embodiment of the present invention;

FIG. 18 is a diagram illustrating ARP information in an embodiment of the present invention;

FIG. 19 is a flowchart for describing processing of setting IP change monitoring information in an embodiment of the present invention; and

FIG. 20 is a flowchart for describing IP change detection processing in an embodiment of the present invention.

### DESCRIPTION OF THE PREFERRED EMBODIMENTS

Hereinafter, a form for implementing the present invention will be described, illustrating a plurality of embodiments.

### First Embodiment

First, a first embodiment will be described in the following order.
1.1 System Configuration
1.2 Configuration of Network Management Server
1.3 Configuration of Network Device
1.4 Contents of Table
1.5 Communication Interruption Operation of When Attack is Detected
1.6 Effects of Embodiments

### [1.1 System Configuration]

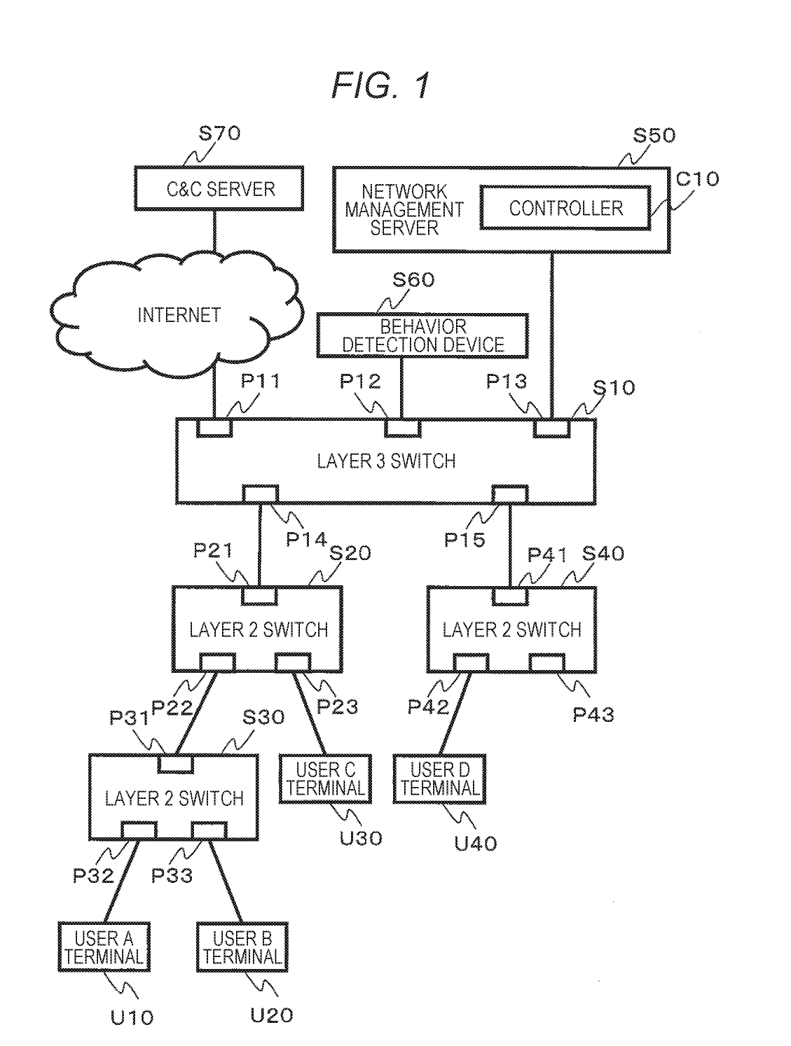

FIG. 1 is an explanatory diagram illustrating a configuration of a network system in an embodiment of the present invention.

The network system in FIG. 1 is configured from a layer 3 switch S10, a layer 2 switch S20, a layer 2 switch S30, and a layer 2 switch S40 that are network devices configuring the network, a network management server S50 that manages the network devices, and a behavior detection device S60 that monitors the network. The network management server includes a controller C10 that is a program operated on the network management server.

The layer 3 switch S10 is connected with the Internet through a port P11, with the behavior detection device S60 through a port P12, with the network management server S50 through a port P13, with the layer 2 switch S20 through a port P14, and with the layer 2 switch S40 through a port P15.

The layer 2 switch S20 is connected with the layer 3 switch S10 through a port P21, with the layer 2 switch S30 through a port P22, and with a user terminal U30 through a port P23.

The layer 2 switch S30 is connected with the layer 2 switch S20 through a port P31, with a user terminal U10 through a port P32, and with a user terminal U20 through a port P33.

The layer 2 switch S40 is connected with the layer 3 switch S10 through a port P41, and with a user terminal U40 through a port P42.

### [1.2 Configuration of Network Management Server]

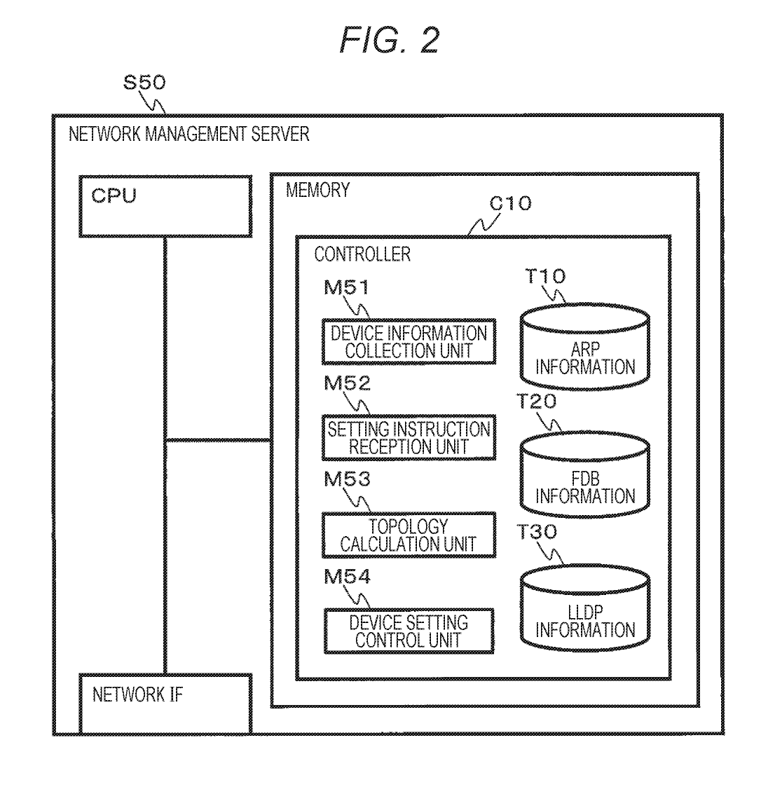

FIG. 2 is an explanatory diagram illustrating a configuration of a network management server in an embodiment of the present invention.

The network management server S50 includes a central processing unit (CPU) for carrying out an operation, a memory for storing a program, and a network interface (IF) for being connected with another network device through a line, and these elements are connected with a bus. The memory stores the controller C10 as a program, and realizes functions of the controller C10 when the CPU executes the program stored in the memory.

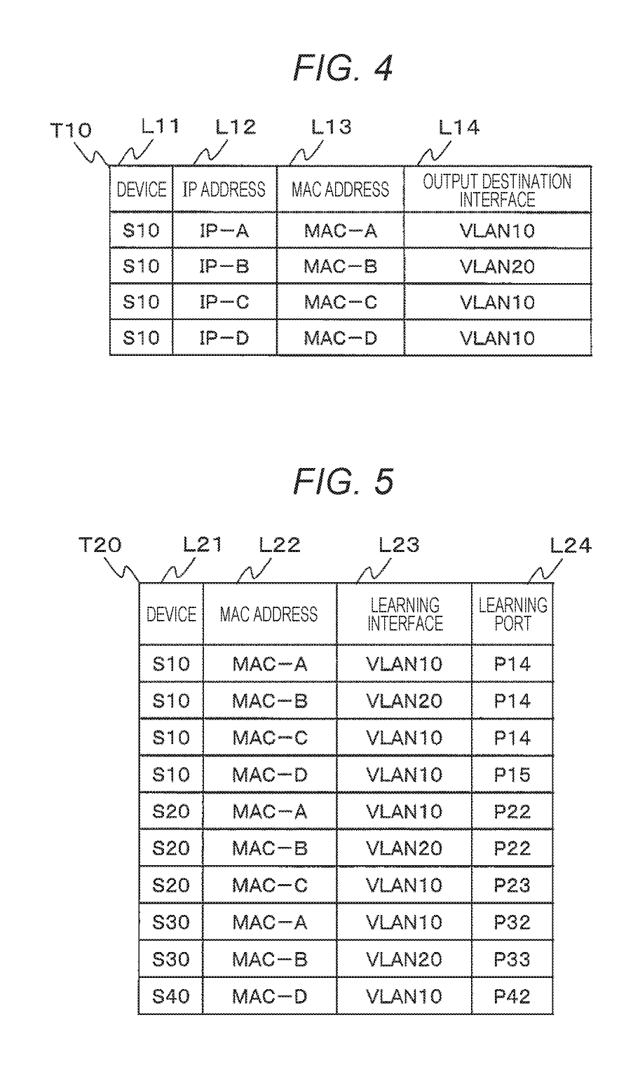

The controller C10 is configured from a device information collection unit M51 that is a module to collect information of the network devices, a setting instruction reception unit M52 that that is a module to receive an instruction from the behavior detection device, a topology calculation unit M53 that identifies a target network device for which a filter or the like is to be set according to the instruction, a device setting control unit M54 that performs setting to the network device, and ARP information T10, FDB information T20, and link layer discovery protocol (LLDP) information T30 that are tables storing the information of the network devices collected by the device information collection unit M51. Contents of the tables will be described in FIGS. 4 to 6.

### [1.3 Details of Network Device]

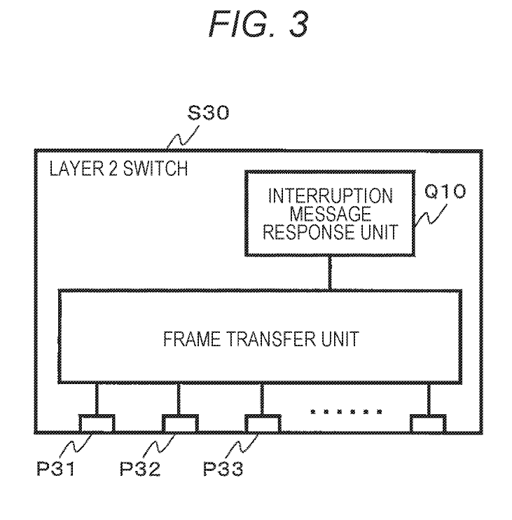

FIG. 3 is an explanatory diagram illustrating a configuration of a network device in an embodiment of the present invention.

Although the layer 2 switches S20 and S40 have a similar configuration in the present embodiment, the layer 2 switch S30 will be described here as an example. Note that the layer 3 switch S10 is different in including a packet relay unit for performing layer 3 relay, in addition to the configuration of the layer 2 switches.

The layer 2 switch S30 includes a plurality of ports (P31, P32, P33, and the like in FIG. 3) for communicating with other network devices and the like. The layer 2 switch S30 includes a frame transfer unit for layer 2 relaying a layer 2 frame received through the port according to a virtual LAN (VLAN), FDB, and a filter function. The layer 2 switch S30 of the present embodiment further includes an interruption message response unit Q10 to respond with an interruption message for notifying a user of discard of the frame with the filter. In the present embodiment, the interruption message response unit Q10 performs snooping of a GET request of a hypertext transfer protocol (HTTP) to be layer 2 relayed, and transmits hypertext markup language (HTML) content for notifying interruption of communication to the user as a response. However, notification of interruption of communication to the user may be by any means.

### [1.4 Contents of Table]

Contents of the tables will be described below.

The ARP information will be described using FIG. 4. The ARP information T10 is generated on the basis of ARP information collected by the controller C10 from the management target network devices (that is, the layer 3 switch S10, the layer 2 switch S20, the layer 2 switch S30, and the layer 2 switch S40), and is configured from a device L11 that is an identifier (ID) for identifying the device of the collection source, an IP address L12, a MAC address L13, and an output destination interface L14. In the present embodiment, only the layer 3 switch S10 performs ARP learning, and thus S10 is stored in the device L11. The user A terminal U10 has an IP address IP-A and a MAC address MAC-A, and belongs to VLAN10, and is thus stored as an entry of the device L11 of S10, the IP address L12 of IP-A, the MAC address L13 of MAC-A, and the output destination interface of VLAN10. The user B terminal U20 is stored as an entry of the device L11 of S10, the IP address L12 of IP-B, the MAC address L13 of MAC-B, and the output destination interface of VLAN20. The user C terminal U30 is stored as an entry of the device L11 of S10, the IP address L12 of IP-C, the MAC address L13 of MAC-C, and the output destination interface of VLAN10. The user D terminal U40 is stored as an entry of the device L11 of S10, the IP address L12 of IP-D, the MAC address L13 of MAC-D, and the output destination interface of VLAN10.

The FDB information will be described using FIG. 5.

The FDB information T20 is generated on the basis of the FDB information collected from the management target network devices by the controller C10, and is configured from a device L21, a MAC address L22, a learning interface L23, and a learning port L24. In the present embodiment, description will be given on the assumption that VLAN10 is configured from the ports P14 and P15 of the layer 3 switch, the ports P21, P22, and P23 of the layer 2 switch S20, the ports P31 and P32 of the layer 2 switch S30, and the ports P41, P42, and P43 of the layer 2 switch S40. MAC-A of the user A terminal U10 learns the port P14 of the layer 3 switch S10, the port P22 of the layer 2 switch S20, and the port P32 of the layer 2 switch S30. As a result, an entry of the device L21 of S10, the MAC address L22 of MAC-A, the learning interface L23 of VLAN10, and the learning port L24 of P14, an entry of the device L21 of S20, the MAC address L22 of MAC-A, the learning interface L23 of VLAN10, and the learning port L24 of P22, and an entry of the device L21 of S30, the MAC address L22 of MAC-A, the learning interface L23 of VLAN10, and the learning port L24 of P32 are stored.

Similarly, as for MAC-C of the user C terminal U30, an entry of the device L21 of S10, the MAC address L22 of MAC-C, the learning interface L23 of VLAN10, and the learning port L24 of P14, and an entry of the device L21 of S20, the MAC address L22 of MAC-C, the learning interface L23 of VLAN10, and the learning port L24 of P23 are stored.

Similarly, as for MAC-D of the user D terminal U40, an entry of the device L21 of S10, the MAC address L22 of MAC-D, the learning interface L23 of VLAN10, and the learning port L24 of P15, and an entry of the device L21 of S40, the MAC address L22 of MAC-D, the learning interface L23 of VLAN10, and the learning port L24 of P42 are stored.

Further, when VLAN20 is configured from the port P14 of the layer 3 switch, the ports P21 and P22 of the layer 2 switch S20, and the port P33 of the layer 2 switch S30, MAC-B of the user B terminal U20 learns the port P14 of the layer 3 switch S10, the port P22 of the layer 2 switch S20, and the port P33 of the layer 2 switch S30. As a result, an entry of the device L21 of S10, the MAC address L22 of MAC-B, the learning interface L23 of VLAN20, and the learning port L24 of P14, an entry of the device L21 of S20, the MAC address L22 of MAC-B, the learning interface L23 of VLAN20, and the learning port L24 of P22, and an entry of the device L21 of S30, the MAC address L22 of MAC-B, the learning interface L23 of VLAN20, and the learning port L24 of P33 are stored.

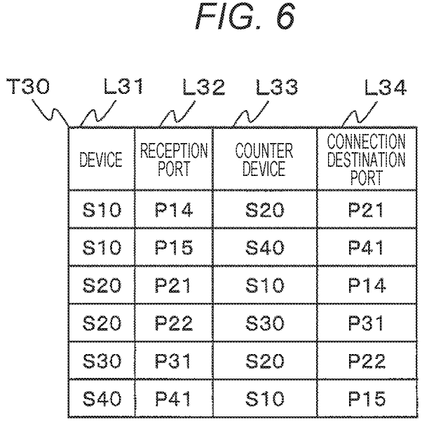

Next, the LLDP information will be described using FIG. 6.

The LLDP information T30 is generated on the basis of LLDP information collected by the controller C10 from the management target network devices, and is configured from a device L31, a reception port L32, a counter device L33, and a connection destination port L34. In the present embodiment, description will be given on the assumption that all the network devices enable the LLDP function, and the network devices transmit an LLDP control frame to adjacent network devices. The layer 3 switch S10 receives the LLDP control frames from the layer 2 switch S20 and the layer 2 switch S40, the layer 2 switch S20 receives the LLDP control frames from the layer 3 switch S10 and the layer 2 switch S30, the layer 2 switch S30 receives the LLDP control frame from the layer 2 switch S20, and the layer 2 switch S40 receives the LLDP control frame from the layer 3 switch S10.

A result of the LLDP information T30 generated by the controller C10 on the basis of LLDP information collected from the management target network devices is illustrated in FIG. 6. An entry of the device L31 of S10, the reception port L32 of P14, the counter device L33 of S20, and the connection destination port L34 of P21, an entry of the device L31 of S10, the reception port L32 of P15, the counter device L33 of S40, and the connection destination port L34 of P41, an entry of the device L31 of S20, the reception port L32 of P21, the counter device L33 of S10, and the connection destination port L34 of P14, an entry of the device L31 of S20, the reception port L32 of P22, the counter device L33 of S30, and the connection destination port L34 of P31, an entry of the device L31 of S30, the reception port L32 of P31, the counter device L33 of S20, and the connection destination port L34 of P22, and an entry of the device L31 of S40, the reception port L32 of P41, the counter device L33 of S10, and the connection destination port L34 of P15 are stored.

For the information tables described in FIGS. 4 to 6, the device information collection unit M51 of the controller C10 periodically executes information collection and update, using means such as the management target network devices (that is, the layer 3 switch S10, the layer 2 switch S20, the layer 2 switch S30, and the layer 2 switch S40) or the simple network management protocol (SNMP).

### [1.5 Communication Interruption Operation of When Attack is Detected]

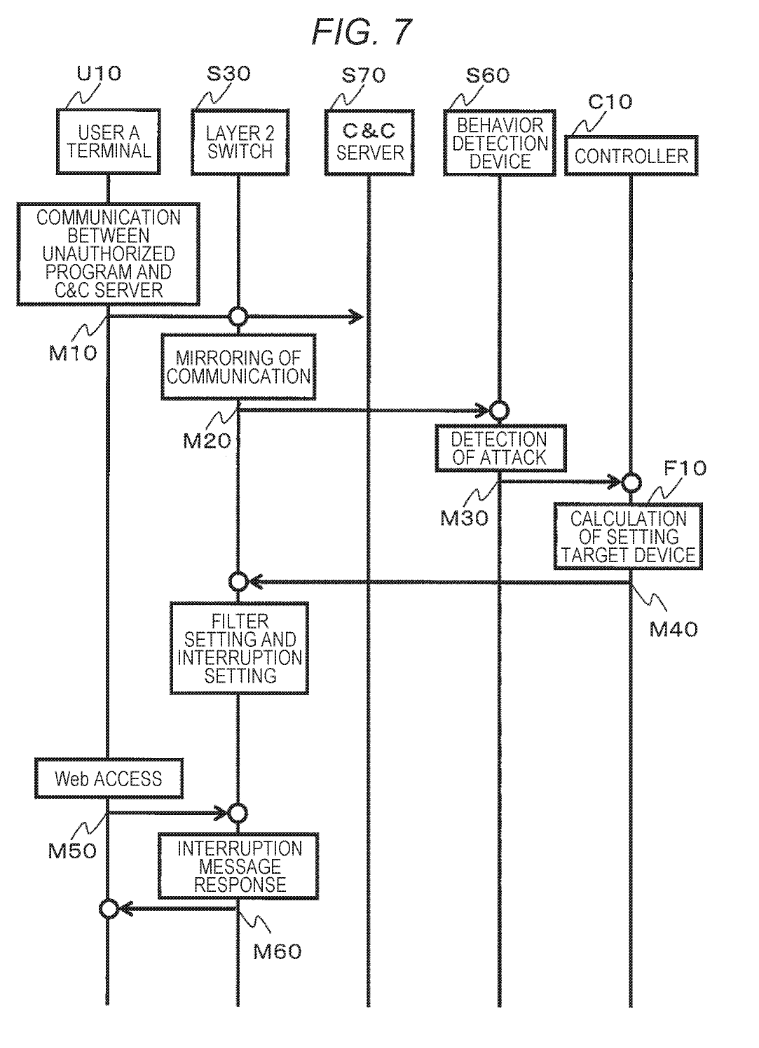

FIG. 7 is a sequence diagram illustrating a communication interruption operation of a network management server in an embodiment of the present invention.

FIG. 7 illustrates a flow of processing in which the user A terminal U10 encounters a targeted cyber attack, the infected user A terminal U10 starts communication by the unauthorized program, the behavior detection device S60 detects the suspicious communication as an attack, and the behavior detection device S60 instructs the controller C10 to interrupt the communication.

The unauthorized program having infected the user A terminal U10 performs communication with the C & C server S70 on the Internet for an attack (M10). The layer 2 switch S30 that is a relay point of the communication mirrors the communication to the behavior detection device S60 (M20). In the present embodiment, the behavior detection device S60 is arranged as an external device connected to the network device and thus the communication is mirrored. However, the network device itself may include the behavior detection device and a mount position of the function is not limited. The behavior detection device S60, which has analyzed the mirrored communication and detected infection of the user A terminal U10 with the unauthorized program, outputs an instruction to the controller C10 to interrupt the communication of IP-A that is the IP address of the user A terminal U10 (M30). The controller C10, which has received the communication interruption instruction M30 from the behavior detection device S60, identifies the target network device to which communication interruption setting is to be set, on the basis of the information collected from the network devices (F10).

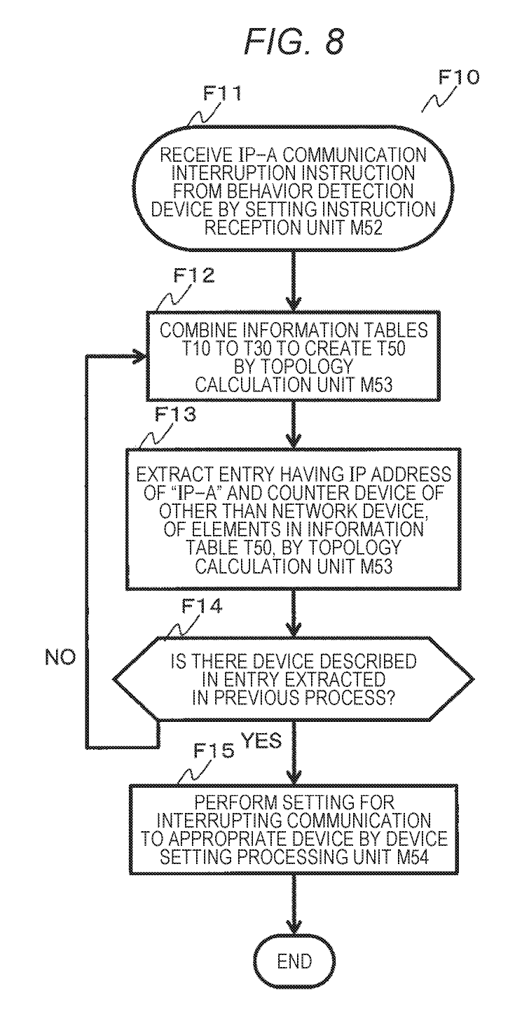

FIG. 8 is a flowchart illustrating details of the processing (F10) of identifying the network device.

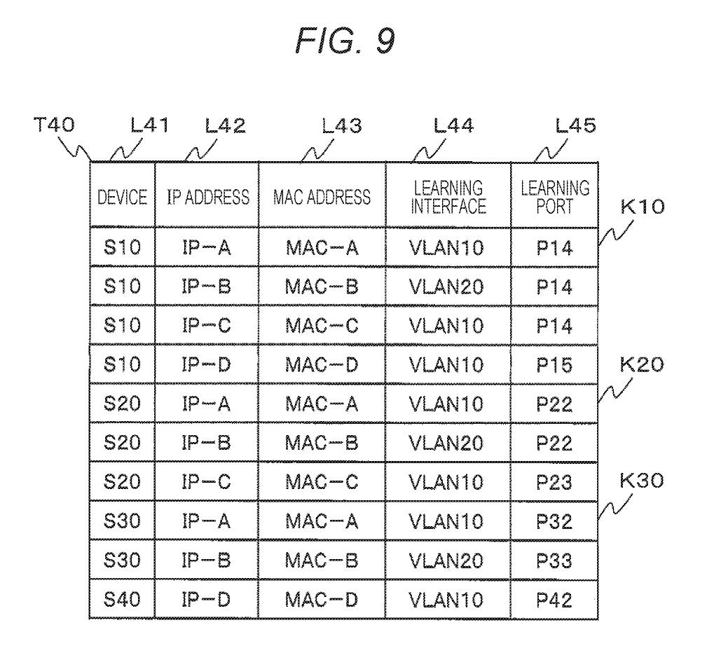

The controller C10, which has received (F11) the communication interruption instruction M30 of IP-A that is the IP address of the user A terminal U10 from the behavior detection device S60 with the setting instruction reception unit M52, creates an information table for narrowing the network device to which filter setting for communication interruption is to be performed, in a combination of the ARP information table T10 and the FDB information table T20, in the topology calculation unit M53. The filter setting target device narrowing information table T40 in FIG. 9 is created in a combination of the ARP information table T10 and the FDB information table T20, in which a value of the MAC address L13 of the ARP information T10 and a value of the MAC address L22 of the FDB information table T20 are the same, and a value of the output destination interface L14 of the ARP information T10 and a value of the learning interface L23 of the FDB information T20 are the same.

The filter setting target device narrowing information table T40 in FIG. 9 includes a device L41, an IP address L42, a MAC address L43, a learning interface L44, and a learning port L45. Here, when narrowing the entries having the value of the IP address L42 of IP-A, an entry K10, an entry K20, and an entry K30, which are filter application candidates, can be extracted. However, if the filter is set to the layer 2 switch S40 indicated by the entry K30, the filters set to the network devices of the entries K10 and K20 become unused wasted filters. Further, even if the filters are set to the layer 3 switch S10 and the layer 2 switch S20, communication between the ports of the layer 2 switch S30 is possible. Therefore, the unauthorized program can infect the user B terminal U20.

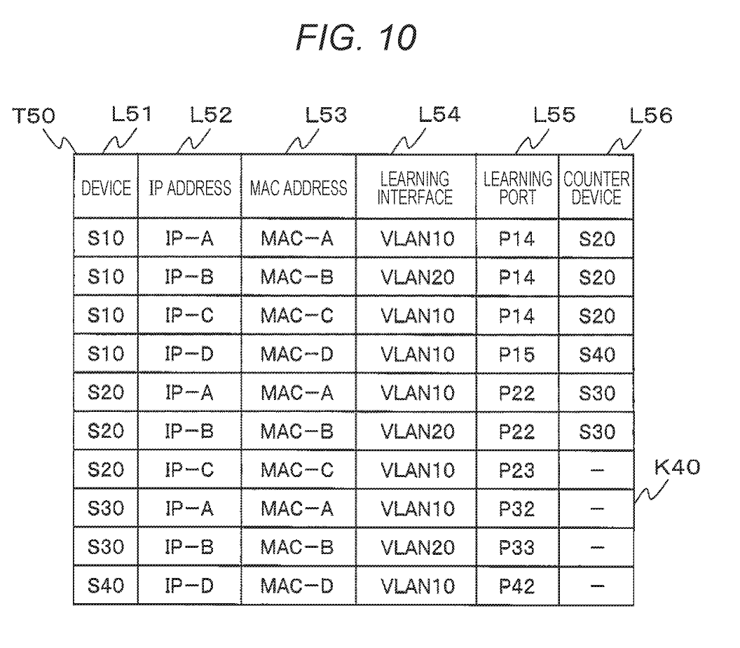

To solve this problem, the information table is created in combination of not only the ARP information T10 and the FDB information T20 but also the LLDP information T30. The filter setting target device identifying information table T50 in FIG. 10 is created in a combination of the ARP information table T10, the FDB information table T20, and the LLDP information T30, in which the value of the MAC address L13 of the ARP information T10 and the value of the MAC address L22 of the FDB information table T20 are the same, the value of the output destination interface L14 of the ARP information T10 and the value of the learning interface L23 of the FDB information T20 are the same, and the value of learning port L24 of the FDB information T20 and the value of the reception port L32 of the LLDP information T30 are the same (F12).

Note that, in the present embodiment, the information table T50 is created upon reception of the communication interruption instruction from the behavior detection device S60. However, the information table T50 may be created upon update of the information tables T10, T20, and T30.

The filter setting target device identifying information T50 in FIG. 10 includes a device L51, an IP address L52, a MAC address L53, a learning interface L54, a learning port L55, and a counter device L56. Here, when narrowing the entries having the value of the IP address L52 of IP-A, and the counter device is not the network device, an entry K40 can be extracted (F13). In a case where no entries can be extracted from the filter setting target device identifying information table T50, the process is repeated until an entry can be extracted from the filter setting target device identifying information table T50 in the topology calculation unit after update of the information tables (F14). The device setting control unit M54 of the controller C10 sets the filter to the layer 2 switch S30 indicated by the entry K40 (F15). Note that, in the present embodiment, determination as to whether the adjacent device is the network device is performed using the LLDP. However, means for the determination is not limited.

Referring back to FIG. 7, the controller C10, which has identified the setting destination device, further performs setting for notifying the user of interruption of communication by filter setting, for the layer 2 switch S30 (M40). The user of the user A terminal U10 that becomes unable to communicate with an outside due to interruption of communication attempts a web access through a web browser for connection confirmation with the Internet or the network (M50). The layer 2 switch, which has received the web access, discards the communication from the user A terminal U10 with the filter, and transmits an interruption message for notifying the interruption of communication to the user of the user A terminal U10 from the interruption message response unit Q10 as a response to the web access (M60). The user, who has the interruption message displayed on the web browser, notices that the user terminal in use has been infected with an unauthorized program early, and can minimize the damage in cooperation with an information system administrator. Note that, in the present embodiment, the layer 2 switch includes the interruption message response unit Q10. However, the interruption message response unit Q10 may be mounted as a program operated on the server, and the mount position is not limited.

### [1.6 Effects of Embodiments]

As described above, in the network system of the first embodiment, communication interruption of the user terminal infected with an unauthorized program can be realized with a least number of filters. Further, display of the interruption message on the web browser of the user can make the user aware of infection with the unauthorized program early.

### Second Embodiment

Next, a second embodiment will be described.

A network configuration in which a hub is provided between a layer 2 switch and a user terminal, a plurality of user terminals is accommodated in the hub, and the hub is connected to a port of the layer 2 switch, in the network configuration illustrated in FIG. 1, will be considered as an example. In such a network configuration, to interrupt communication of a terminal infected with an unauthorized program and continue communication of terminals other than the infected terminal, setting an IP address or a MAC address of the terminal, communication of which is to be interrupted, to a filter of the layer 2 switch can be considered. In a case where the IP address or the MAC address of the terminal, communication of which is to be interrupted, is set to the filter, when a user of the terminal infected with the unauthorized program connects the terminal to a port of another layer 2 switch, the user can continue communication.

The second embodiment is an embodiment that detects movement and realizes communication interruption in a case where a terminal infected with an unauthorized program is carried out and connected with a port of another layer 2 switch.

In the present embodiment, a technology to detect, by a controller of a network management server, connection of a communication interruption target terminal with a port of another layer 2 switch, and set a filter for interrupting communication to the port at the destination will be described in the following order.
2.1 Configuration of Network Management Server
2.2 Contents of Table
2.3 Storage of Port Movement Monitoring Information
2.4 Communication Interruption Operation of When Port Movement is Detected
2.5 Effects of Embodiments

### [2.1 Configuration of Network Management Server]

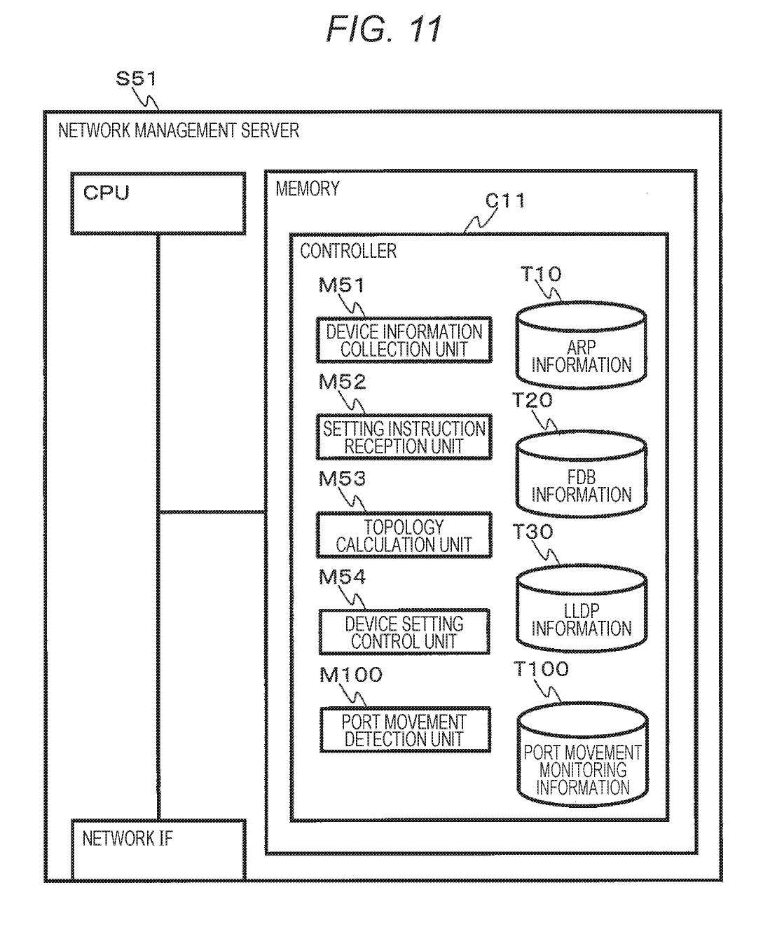

FIG. 11 is a diagram for describing a configuration of a network management server in a second embodiment of the present invention.

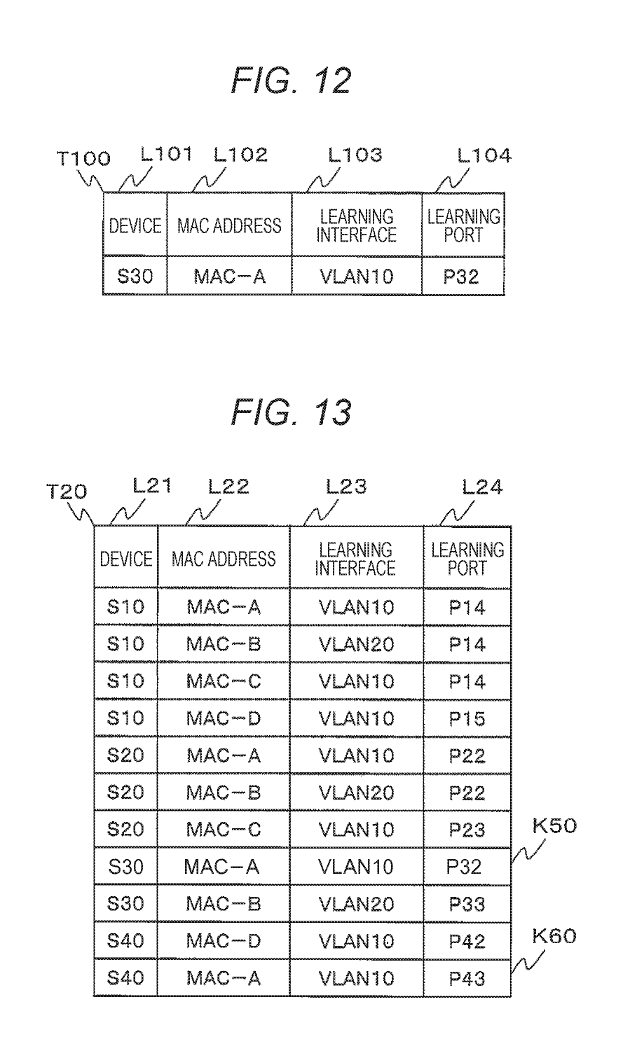

A network management server S51 in FIG. 11 includes a port movement detection unit M100 and port movement monitoring information T100, in addition to the configuration of the network management server S50 described in the first embodiment. The port movement detection unit M100 is a module that detects port movement of a communication interruption target. The port movement monitoring information T100 is a table that stores information for monitoring the port movement. Contents of the table of the port movement monitoring information T100 will be described in FIG. 12.

### [2.2 Contents of Table]

FIG. 12 is a diagram for describing the port movement monitoring information.

The port movement monitoring information T100 is information for monitoring port movement of a terminal of which communication has been interrupted, and stores a device L101, a MAC address L102, a learning interface L103, and a learning port L104.

FIG. 12 illustrates stored information, using a case in which communication of IP-A is interrupted as an example according to the first embodiment. In the example in FIG. 12, the port movement monitoring information T100 stores an entry of the device L101 of device S30, the MAC address L102 of MAC-A, the learning interface L103 of VLAN10, and the learning port L104 of port P32.

FIG. 13 illustrates an FDB information table in the second embodiment.

The device information collection unit M51 of a controller C11 periodically collects information from management target network devices and updates tables. When the device information collection unit M51 detects linking-down of the port P32 of the layer 2 switch S30, the device information collection unit M51 discards an entry K50 of the device L21 of S30, the MAC address L22 of MAC-A, the learning interface L23 of VLAN10, and the learning port L24 of P32. Further, the device information collection unit M51 detects connection of the user A terminal U10 to the layer 2 switch S40 and up-linking of the port P43, and learns and stores an entry K60 of the device L21 of S40, the MAC address L22 of MAC-A, the learning interface L23 of VLAN10, and the learning port L24 of P43.

### [2.3 Storage of Port Movement Monitoring Information]

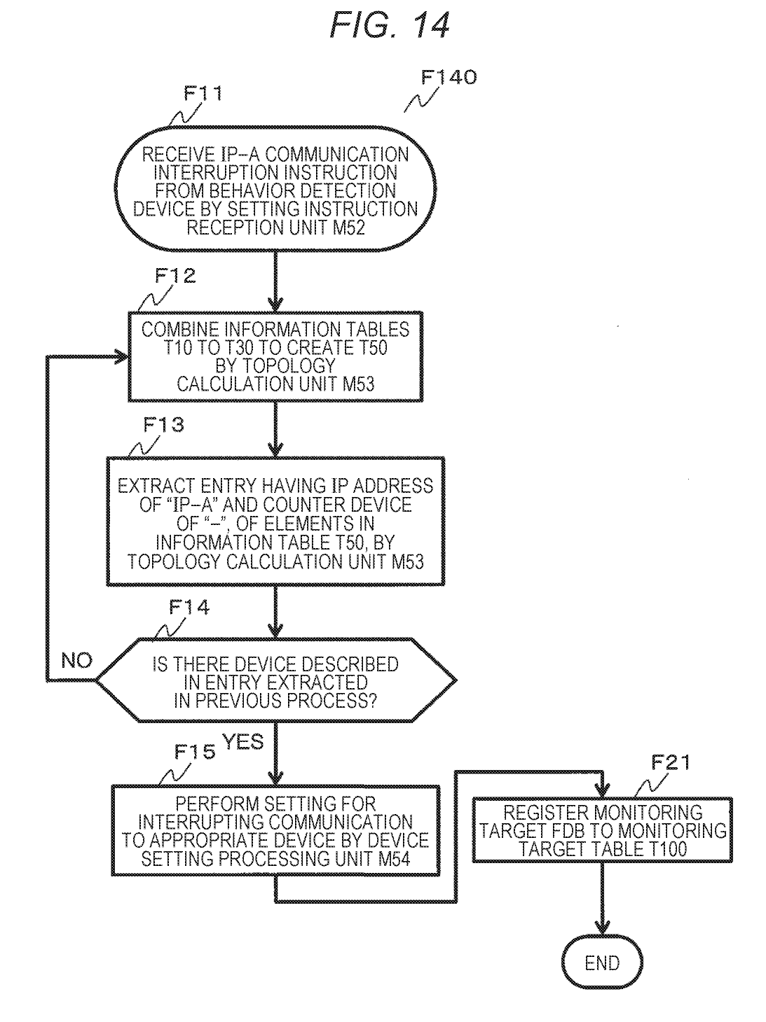

FIG. 14 is a flowchart illustrating processing (F140) of identifying a network device and storing information of a monitoring target to the monitoring information T100 in the second embodiment of the present invention.

A different point from the flowchart (FIG. 8) of the first embodiment is in further including processing (F21) of storing communication interruption target FDB information (FDB entry) to the monitoring information T100, in addition to the processing of detecting an attack and performing a communication interruption operation in the first embodiment.

### [2.4 Communication Interruption Operation of When Port Movement is Detected]

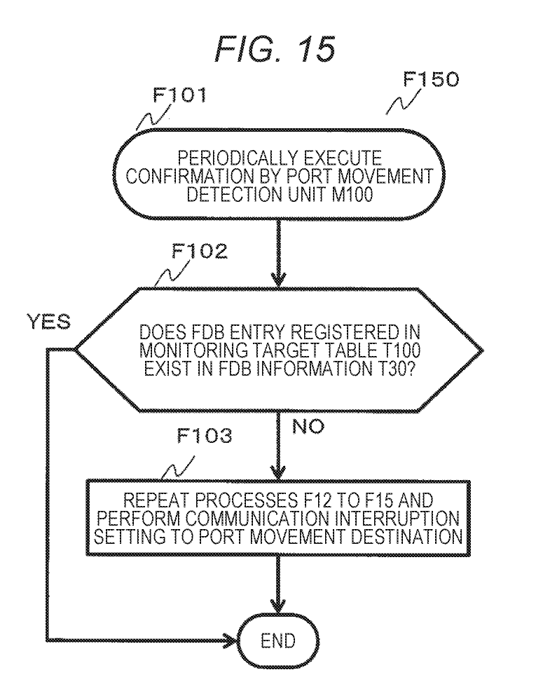

FIG. 15 is a flowchart illustrating processing of detecting port movement and setting communication interruption to the port at the destination (F150) in the second embodiment of the present invention.

The port movement detection unit M100 of the controller C11 periodically (F101) confirms whether an entry corresponding to the FDB entry registered in the port movement monitoring information T100 exists in an FDB information table T20 (F102). In a case where an appropriate FDB entry exists in the FDB information table T20, the processing is terminated. In a case where no appropriate FDB entry exists in the FDB information table T20, steps F12 to F15 in FIG. 8 are performed, and communication interruption setting to the port after the movement is performed (F103). In the present embodiment, as the port movement monitoring information T100, the entry of the device L101 of S30, the MAC address L102 of MAC-A, the learning interface L103 of VLAN10, and the learning port L104 of port P32 is registered as illustrated in FIG. 12. The port movement detection unit M100 monitors movement of the monitoring target terminal by processing (F102) of confirming whether the entry K50 in the FDB information table T20, which corresponds to the monitoring target entry, exists in the FDB information table. The port movement detection unit M100 detects movement of the port as the FDB information corresponding to the monitoring target entry becomes non-existent in the FDB information table. Further, communication interruption becomes possible by performing communication interruption setting again after detection of the movement of the port.

In a case where a user terminal is directly connected with a network device that cannot learn the FDB information, like a network configured from a router instead of the layer 3 switch, down of a port may be used for detection of the movement of a port. Further, the port movement detection processing may be performed at timing determined in advance or upon an instruction of a server administrator, other than the periodic operation.

### [2.5 Effects of Embodiments]

As described above, in the second embodiment, even if the user terminal infected with an unauthorized program is moved after the communication is interrupted, and is connected with another port of another layer 2 switch to resume the communication, the port movement is detected and the communication interruption setting can be performed again.

### Third Embodiment

Next, a third embodiment will be described.

The third embodiment is an embodiment to realize communication interruption even in a case where an IP address of a terminal infected with an unauthorized program is changed.

As exemplarily described in the second embodiment, in a case where an IP address of a terminal, of which communication is to be interrupted, is set to a filter of a layer 2 switch, communication can be continued if the IP address of the terminal infected with the unauthorized program is changed.

Therefore, in the present embodiment, a configuration in which a controller of a network management server detects change of an IP address of a target terminal, of which communication has been interrupted, and sets communication interruption to the IP address after change will be described in the following order.
3.1 Configuration of Network Management Server
3.2 Contents of Table
3.3 Storage of IP Address Change Monitoring Information
3.4 Communication Interruption Operation of When Change of IP Address is Detected
3.5 Effects of Embodiments

### [3.1 Configuration of Network Management Server]

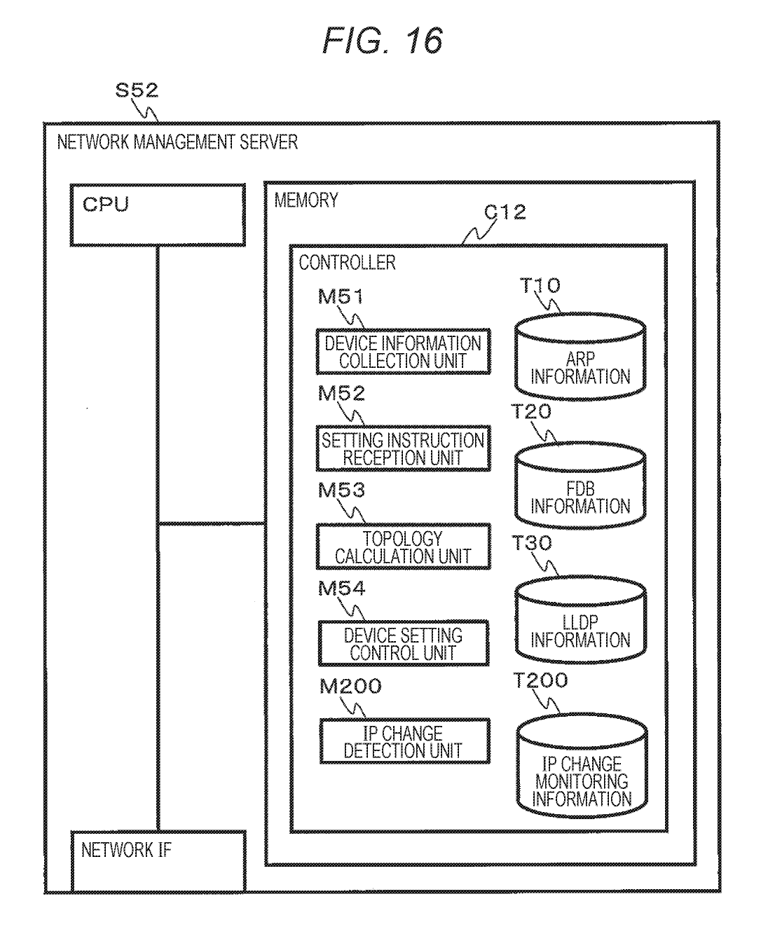

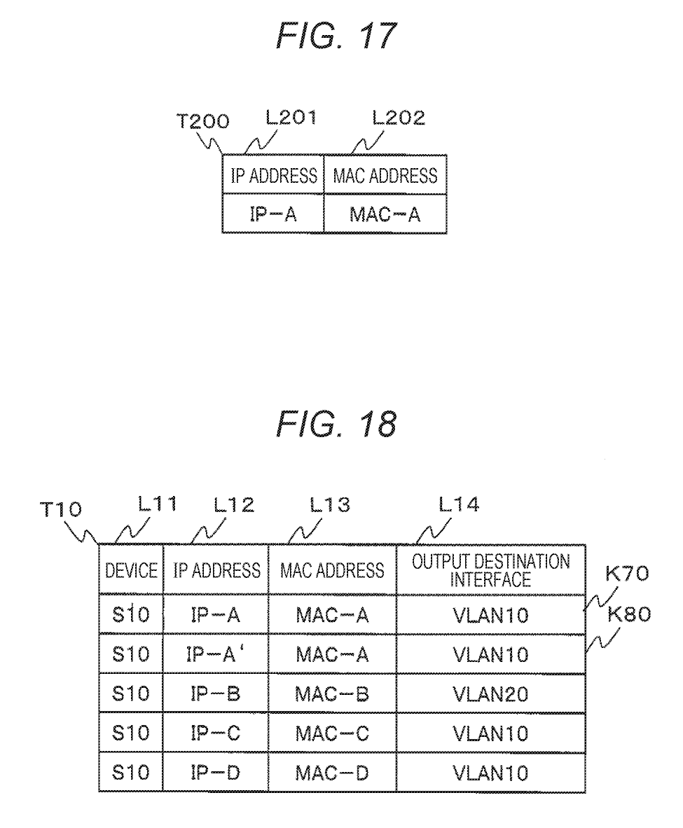

FIG. 16 is a diagram for describing a configuration of a network management server S52 in the third embodiment of the present invention. The network management server S52 includes an IP change detection unit M200 and IP change monitoring information T200, in addition to the configuration of the network management server S50 in the first embodiment illustrated in FIG. 2. The IP change detection unit M200 is a module that detects change of an IP address of a communication interruption target terminal. The IP change monitoring information T200 is a table that stores information for monitoring the change of an IP address. Contents of the table of the IP change monitoring information T200 will be described in FIG. 17.

### [3.2 Contents of Table]

The IP change monitoring information T200 in FIG. 17 is a table that stores information for monitoring change of an IP address of a terminal, of which communication has been interrupted, and stores an IP address L201 and a MAC address L202. FIG. 17 illustrates an example of storing information corresponding to IP-A, of which the communication has been interrupted in the first embodiment, and an entry of the IP address L201 of IP-A and the MAC address L202 of MAC-A is stored.

FIG. 18 is a diagram illustrating an ARP information table in the third embodiment.

The IP address of a user A terminal U10 having the IP address IP-A as the IP change monitoring target is changed from IP-A to IP-A′, and the user A terminal U10 starts communication with IP-A′. The IP change detection unit M200 learns an entry K70 of the device L11 of S10, the IP address L12 of IP-A′, the MAC address L13 of MAC-A, and the output destination interface L14 of VLAN10, and stores the entry to the ARP information table.

### [3.3 Storage of IP Address Change Monitoring Information]

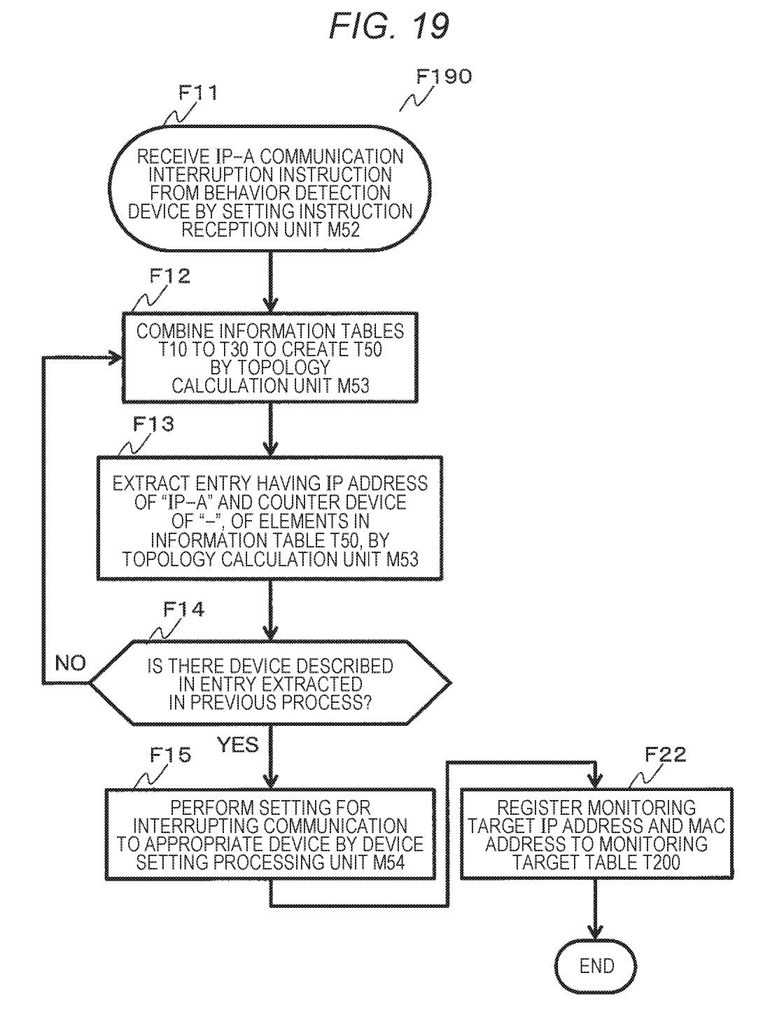

FIG. 19 is a flowchart illustrating processing (F190) of identifying a network device and storing information of a monitoring target to the IP change monitoring information T200 in the third embodiment of the present invention.

A different point from the flowchart (FIG. 8) of the first embodiment is in further including processing (F22) of storing a set of a MAC address and an IP address, which is information of the communication interruption target, to the IP change monitoring information T200, in addition to the processing of a communication interruption operation in the first embodiment.

In the present embodiment, as the IP change monitoring information T200, an entry of the IP address L201 of IP-A and the MAC address L202 of MAC-A is registered.

### [3.4 Communication Interruption Operation of When Change of IP Address is Detected]

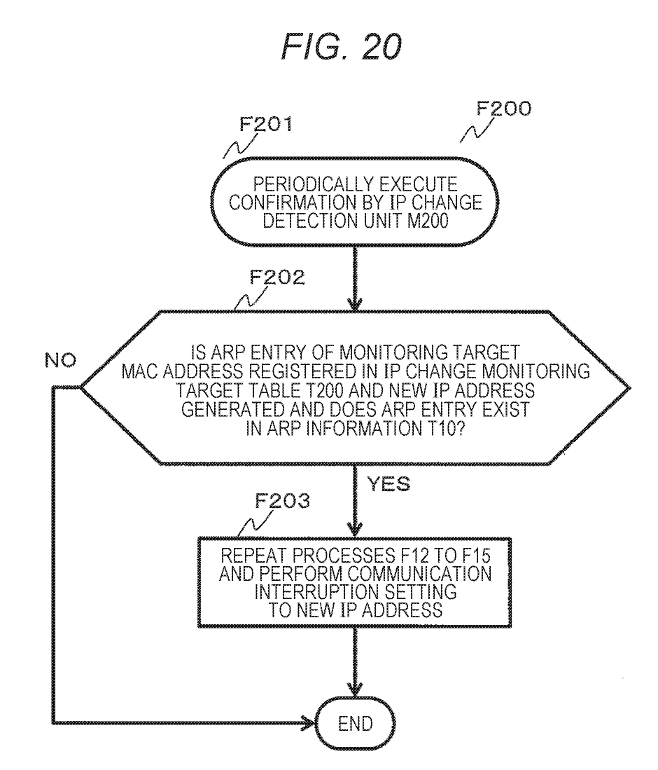

FIG. 20 is a flowchart illustrating processing of detecting change of the IP address and processing (F200) of setting communication interruption to the IP address after change in the third embodiment. The IP change detection unit M200 of a controller C12 periodically (F201) confirms whether an ARP entry corresponding to the set of a MAC address and an IP address registered in the IP change monitoring information T200 exists in an ARP information table T10 (F202). In a case where no entry exists other than the ARP entry of a combination of the monitoring target MAC address and the IP address registered in the IP change monitoring information T200, in the ARP information table T10, processing is terminated. In a case where an ARP entry of a combination of the monitoring target MAC address and a new IP address not registered in the IP change monitoring information T200 exists in the ARP information table T10, in addition to the entry of a combination of the monitoring target MAC address and the IP address registered in the IP change monitoring information T200, the processing F12 to F15 in FIG. 8 is performed for the new IP address, and the communication interruption setting to the new IP address (after change) is performed (F203).

In the present embodiment, as the IP change monitoring information T200, an entry of the IP address L201 of IP-A and the monitoring target device MAC address L202 of MAC-A is registered as monitoring information. When the terminal of the monitoring target MAC address changes the IP address and continues the communication, an entry K80 of the ARP information table T20 is generated. The IP change detection unit M200 detects change of the IP address through the generation of the entry K80. Further, the IP change detection unit M200 can interrupt the communication by performing communication interruption setting again to the IP address after change, after detecting the change of the IP address. Note that the IP address change detection processing may be performed at timing determined in advance or upon an instruction of a server administrator, other than the periodic operation.

### [3.5 Effects of Embodiments]

As described above, in the controller of the third embodiment, even if the IP address of the user terminal infected with an unauthorized program is changed to another IP address after the communication is interrupted, and the user terminal tries to resume the communication, the change of the IP address is detected and the communication interruption setting can be performed again.

What is claimed is:

1. A network system including at least one layer 3 switch and a plurality of layer 2 switches, the network system further comprising:
a behavior detection unit configured to monitor a behavior of communication of the network system and detect an attack; and
a network management unit configured to receive a detection result output by the behavior detection unit, identify a target switch for which setting for interrupting the attack detected by the behavior detection unit is to be performed, from the layer 3 switch and the layer 2 switches, on the basis of information for associating the detection result and addresses allocated to terminal devices accommodated in the switches, learning information of ports of the switches, and adjacency information of the switches, and perform the setting for interrupting the attack to the identified switch.

2. The network system according to claim 1, wherein,
in a case where the detection result output by the behavior detection unit is an IP address of an attacked terminal device,
the network management unit identifies a layer 2 switch having a smallest number of hops from the attacked terminal device, on the basis of the information for associating addresses allocated to terminal devices accommodated in the switches and the IP address of the attacked terminal device, the learning information of ports of the switches, and the adjacency information of the switches, and sets a filter that interrupts communication of the attacked terminal device to the identified layer 2 switch.

3. The network system according to claim 2, further comprising:
an interruption message notification unit configured to notify interruption of communication because the attack has been detected, to the terminal device, of which the communication has been interrupted.

4. A network controller in a network system including at least one layer 3 switch and a plurality of layer 2 switches, the network controller being configured to receive a detection result output by a behavior detection unit that monitors a behavior of communication of the network system and detects an attack, identify a target switch for which setting for interrupting the attack detected by the behavior detection unit is to be performed, from the layer 3 switch and the layer 2 switches, on the basis of information for associating the detection result and addresses allocated to terminal devices accommodated in the switches, learning information of ports of the switches, and adjacency information of the switches, and perform the setting for interrupting the attack to the identified switch.

5. The network controller according to claim 4, wherein,
in a case where the detection result output by the behavior detection unit is an IP address of an attacked terminal device,
the network controller identifies a layer 2 switch having a smallest number of hops from the attacked terminal device, on the basis of the information for associating addresses allocated to terminal devices accommodated in the switches and the IP address of the attacked terminal device, the learning information of ports of the switches, and the adjacency information of the switches, and sets a filter that interrupts communication of the attacked terminal device to the identified layer 2 switch.

6. The network controller according to claim 5, wherein
the network controller further performs setting for notifying, to the identified layer 2 switch, interruption of communication because the attack has been detected, to the terminal device, of which the communication has been interrupted.

7. A switch in a network system including a plurality of the switches and a server that manages the plurality of switches, the switch comprising
at least a frame transfer unit and an interruption message response unit, wherein
the switch is configured to set a filter that interrupts communication of a terminal device specified from the server to the frame transfer unit, and the interruption message response unit is configured to transmit an interruption message that notifies interruption of communication to the terminal device, of which the communication has been interrupted with the filter, when the switch receives a frame from the terminal device.
